(19) United States
(12) Patent Application Publication
(10) Pub. No.: US 2017/0152860 A1
(43) Pub. Date: Jun. 1, 2017

(54) COMPRESSOR INLET GUIDE VANES

(71) Applicant: BorgWarner Inc., Auburn Hills, MI (US)

(72) Inventors: Mihai Miclea-Bleiziffer, Worms (DE); Sascha Karstadt, Undenheim (DE); Urs Hanig, Stuttgart (DE)

(21) Appl. No.: 14/954,146

(22) Filed: Nov. 30, 2015

(51) Int. Cl. F04D 29/44; F04D 29/46

(52) U.S. Cl. CPC F04D 29/444; F04D 29/462; F05B 2220/40; F05B 2240/12; F05B 2250/71; F05B 2250/60; F05B 2250/12

(57) ABSTRACT

A number of variations may include a method of optimizing inlet guide vane performance comprising: modifying an inlet guide vane to include at least one of a twist, a curve, a surface texture, a sealing feature, a tip leakage reduction feature, an airfoil having at least one component, or at least one channel.

### TECHNICAL FIELD

The field to which the disclosure generally relates to includes turbocharged internal combustion engines.

### BACKGROUND

A vehicle may include a turbocharger which may utilize exhaust gases to drive a turbine that may be operatively connected to, and which may drive a compressor. The compressor may be used to compress combustion air into the engine's intake manifold.

### SUMMARY OF ILLUSTRATIVE VARIATIONS

A number of variations may include a method of optimizing inlet guide vane performance comprising: modifying an inlet guide vane to include at least one of a twist, a curve, a surface texture, a sealing feature, a tip leakage reduction feature, an airfoil having at least one component, or at least one channel.

A number of variations may include a product comprising: an inlet guide vane having at least one of a twisted blade, a curved blade, a surface texture, a sealing feature, a blocking feature, an airfoil having at least one component, or at least one channel.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a section view of an inlet swirl device according to a number of variations.

FIG. 2 illustrates a front view of a standard vane according to a number of variations.

FIG. 3 illustrates a section view taken along A-A of FIG. 2 according to a number of variations.

FIG. 4 illustrates a perspective view of a vane with a twist according to a number of variations.

FIG. 5 illustrates a perspective view of a vane with a twist according to a number of variations.

FIG. 6 illustrates a front view of a vane with a twist according to a number of variations.

FIG. 7 illustrates a section view taken along A-A of FIG. 6 according to a number of variations.

FIG. 8 illustrates a section view of an inlet swirl device with the vanes open according to a number of variations.

FIG. 9 illustrates a section view of an inlet swirl device with the vanes closed according to a number of variations.

FIG. 10 illustrates a perspective view of a vane with a twist according to a number of variations.

FIG. 11 illustrates a perspective view of a vane with a twist according to a number of variations.

FIG. 12 illustrates a front view of a vane with a twist according to a number of variations.

FIG. 13 illustrates a section view taken along A-A of FIG. 12 according to a number of variations.

FIG. 14 illustrates a section view of an inlet swirl device where the vanes are open according to a number of variations.

FIG. 15 illustrates a section view of an inlet swirl device where the vanes are closed according to a number of variations.

FIG. 16 illustrates a perspective view of a vane with a curved center line according to a number of variations.

FIG. 17 illustrates a perspective view of a vane with a curved center line according to a number of variations.

FIG. 18 illustrates a front view of a vane with a curved center line according to a number of variations.

FIG. 19 illustrates a section view taken along A-A of FIG. 18 according to a number of variations.

FIG. 20 illustrates a section view of an inlet swirl device where the vanes are open according to a number of variations.

FIG. 21 illustrates a section view of an inlet swirl device where the vanes are closed according to a number of variations.

FIG. 22 illustrates a section view of an inlet swirl device where the vanes are open according to a number of variations.

FIG. 23 illustrates a perspective view of a vane with a swept blade according to a number of variations.

FIG. 24 illustrates a perspective view of a vane with an owl construction according to a number of variations.

FIG. 25 illustrates a front view of a vane with an owl construction according to a number of variations.

FIG. 26 illustrates a section view taken along A-A of FIG. 25 according to a number of variations.

FIG. 27 illustrates a section view of an inlet swirl device where the vanes are open according to a number of variations.

FIG. 28 illustrates a section view of an inlet swirl device where the vanes are closed according to a number of variations.

FIG. 29 illustrates a perspective view of a vane with a whale construction according to a number of variations.

FIG. 30 illustrates a front view of a vane with a whale construction according to a number of variations.

FIG. 31 illustrates a section view taken along A-A of FIG. 30 according to a number of variations.

FIG. 32 illustrates a section view of an inlet swirl device where the vanes are open according to a number of variations.

FIG. 33 illustrates a section view of an inlet swirl device where the vanes are closed according to a number of variations.

FIG. 34 illustrates a perspective view of a vane with a golf ball construction according to a number of variations.

FIG. 35 illustrates a front view of a vane with a golf ball construction according to a number of variations.

FIG. 36 illustrates a section view taken along A-A of FIG. 35 according to a number of variations.

FIG. 37 illustrates a section view of an inlet swirl device where the vanes are open according to a number of variations.

FIG. 38 illustrates a section view of an inlet swirl device where the vanes are closed according to a number of variations.

FIG. 39 illustrates a perspective view of a vane with a golf ball construction according to a number of variations.

FIG. 40 illustrates a front view of a vane with a golf ball construction according to a number of variations.

FIG. 41 illustrates a section view taken along A-A of FIG. 40 according to a number of variations.

FIG. 42 illustrates a section view of an inlet swirl device where the vanes are open according to a number of variations.

FIG. 43 illustrates a section view of an inlet swirl device where the vanes are closed according to a number of variations.

FIG. 44 illustrates a perspective view of a vane with a winglet construction according to a number of variations.

FIG. 45 illustrates a front view of a vane with a winglet construction according to a number of variations.

FIG. 46 illustrates a section view taken along A-A of FIG. 45 according to a number of variations.

FIG. 47 illustrates a section view of an inlet swirl device where the vanes are open according to a number of variations.

FIG. 48 illustrates a section view of an inlet swirl device where the vanes are closed according to a number of variations.

FIG. 49 illustrates a section view of an inlet swirl device where the vanes are open according to a number of variations.

FIG. 50 illustrates a perspective view of a vane having a sphere tip according to a number of variations.

FIG. 51 illustrates a perspective view of a vane having a flap according to a number of variations.

FIG. 52 illustrates a perspective view of a vane having multiple flaps according to a number of variations.

FIG. 53 illustrates a perspective view of a vane having a plurality of channels according to a number of variations.

FIG. 54 illustrates a perspective view of a vane having a channel according to a number of variations.

### DETAILED DESCRIPTION OF ILLUSTRATIVE VARIATIONS

The following description of the variations is merely illustrative in nature and is in no way intended to limit the scope of the invention, its application, or uses.

In a number of variations, an engine breathing system may include a turbocharger. The turbocharger may include a turbine which may be operatively attached to a compressor via a shaft. The turbine may be driven by the exhaust gas fluid-flow which may cause the shaft to rotate which may then drive the compressor. The compressor may then pressurize air which may enter the internal combustion engine.

In a number of variations, an inlet swirl device 78 may be located before or upstream of the compressor and may be operatively associated with the compressor. The inlet swirl device 78 may be operable to selectively influence flow by inducing a swirl motion or may be used to selectively restrict flow or substantially prevent flow through the inlet swirl device 78.

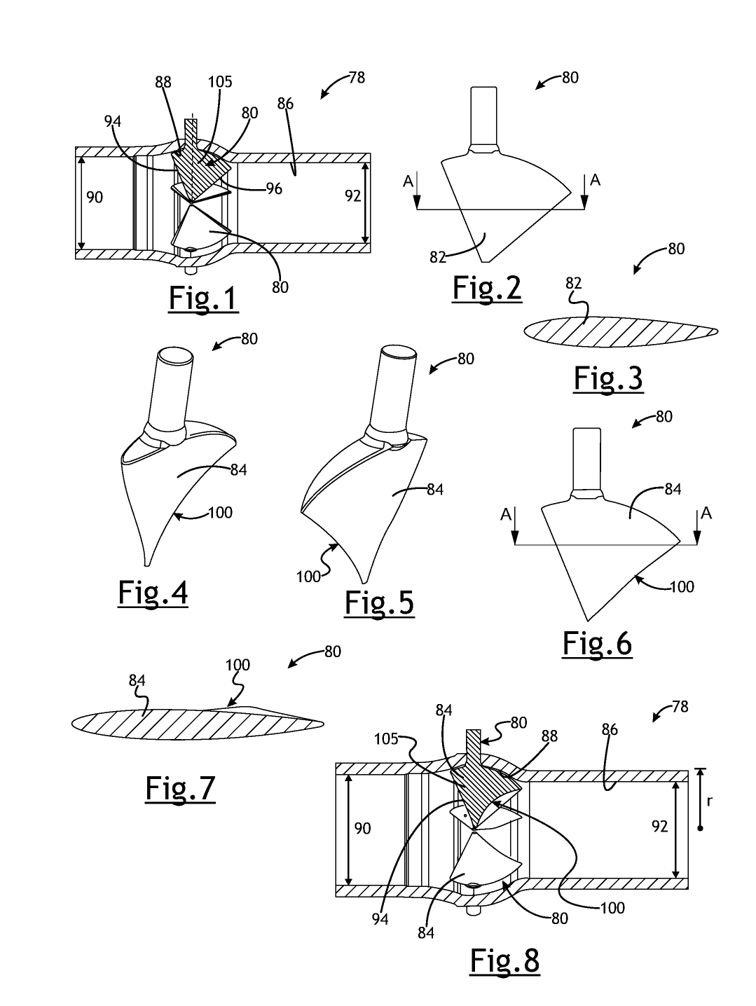

Referring to FIG. 1, in a number of variations, an inlet swirl device 78 may include an inlet port 90, a flow channel 86, a plurality of inlet guide vanes (IGVs) 80 within the flow channel 86, and an outlet port 92 operatively connected to the compressor. The plurality of IGVs 80 may each include a leading edge 94 and a trailing edge 96. The IGV flow channel 86 may include a spherical outer contour 88 which may house the plurality of IGVs 80. The geometry of the spherical outer contour 88 may be determined by the compensation of the inlet port 90 by the through surface 105 of the IGV 80. The ratio between the inlet port 90 area and the outlet port 92 area is always higher than 1. The rotational axis of the IGV 80 may be placed at approximately a quarter profile length from the leading edge 94 of the IGV 80 which may reduce the drive torque required for rotation. The leading edge 94 of the IGV 80 may be covered by the spherical outer contour 88 at an open position, a closed position, or any position therebetween, which may reduce tip losses and flow misalignments. It is noted, however, that any flow channel known to those skilled in the art may be used with the following invention.

In a number of variations, the IGVs 80 may be used to shift the compressor working points, increase the stability of the compressor at surge, and/or to extend the compressor operating map. During mid compressor map operation, a straight flow at the compressor inlet may be optimal for the compressor performance; however, when the compressor is running under off design conditions, a certain amount of pre-swirl may be beneficial. The IGVs 80 may be used as standard IGVs or as an inlet swirl throttle where the IGV closing angles up to 90 degrees are used to throttle fresh air flow and therefore induce low pressure exhaust gas recirculation flow.

In a number of variations, the swirl demand of the compressor wheel at its inlet may be driven by wheel geometry and operating point. For typical wheel geometries the swirl demand over the flow channel radius r is not linear within the whole operating range. Therefore, the use of a standard IGV blade 82, a variation of which is illustrated in FIGS. 2-3, is not ideal as it may generate a linear swirl profile over r, and may allow gaps between the IGVs 80 and the flow channel 86, which may induce secondary flow which may be prone to losses and may reduce performance.

In a number of variations, the geometry of the IGV blades 84 may be modified to optimize performance of the IGVs 80. In a number of variations, the IGV blades 84 may be modified to include a twist or curve 100, 102, 104, 138 which may be used to tailor the pre-swirl level (circumferential speed component) over the flow channel radius r. In a number of variations, the IGV blades 84 may be modified to reduce pressure losses through surface modification 106, 112, 116 of the IGV blades 84. In a number of variations, the IGV blades 84 may be modified to reduce secondary flow by including a sealing feature 120, and/or a feature reducing the tip 128 leakage 126. In a number of variations, the IGV blades 84 may be modified to improve flow using an airfoil comprising one or more parts 130, 132, and/or modifying the IGV blade 84 to include one or more channels 134, 136. In a number of variations, the IGV blades 84 may be modified to include a combination of the above modifications.

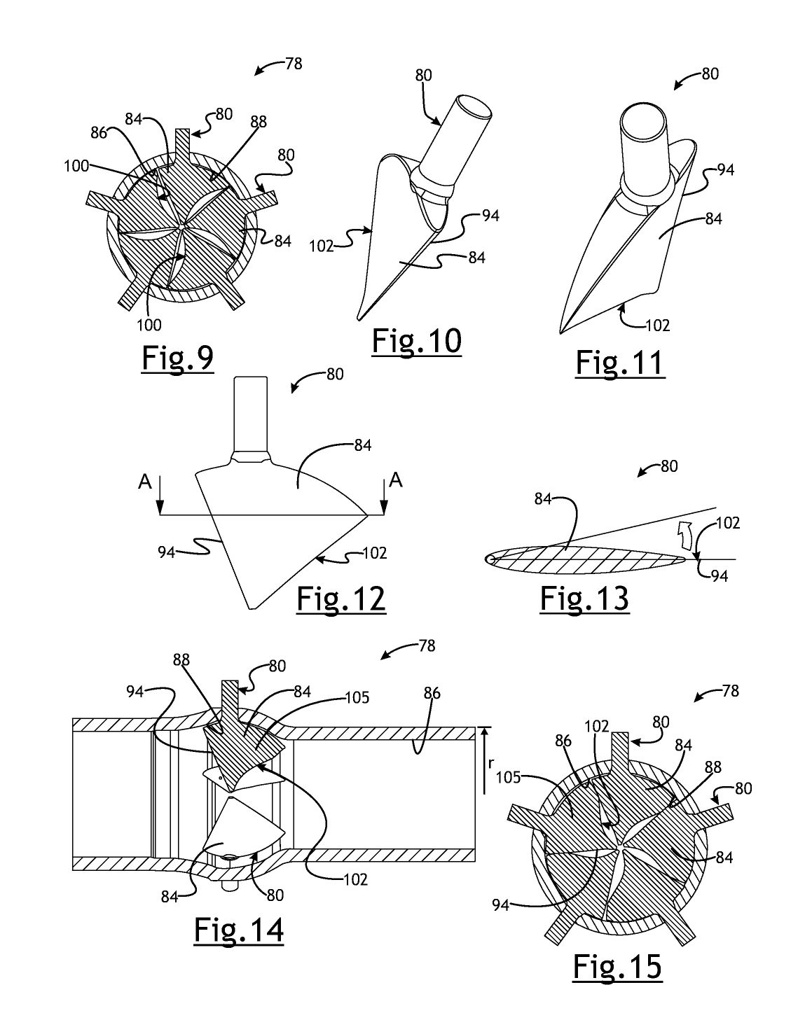

Referring to FIGS. 4-23, in a number of variations, in order to meet the compressor inlet 90 requirements and to reduce the blade pressure losses at a particular operating point in the compressor map, the IGV blades 84 may be twisted 100, 102 or curved 104 along the rotational axis according to the particular operating point in the compressor map. The modified IGV blade 84 configurations may also stabilize the flow around the IGV blade 84 so that they may be operated under a higher angle of attack without flow separations. The twist 100, 102 or curve 104 of the IGV blades 84 may be fixed or adjustable having a morphing geometry.

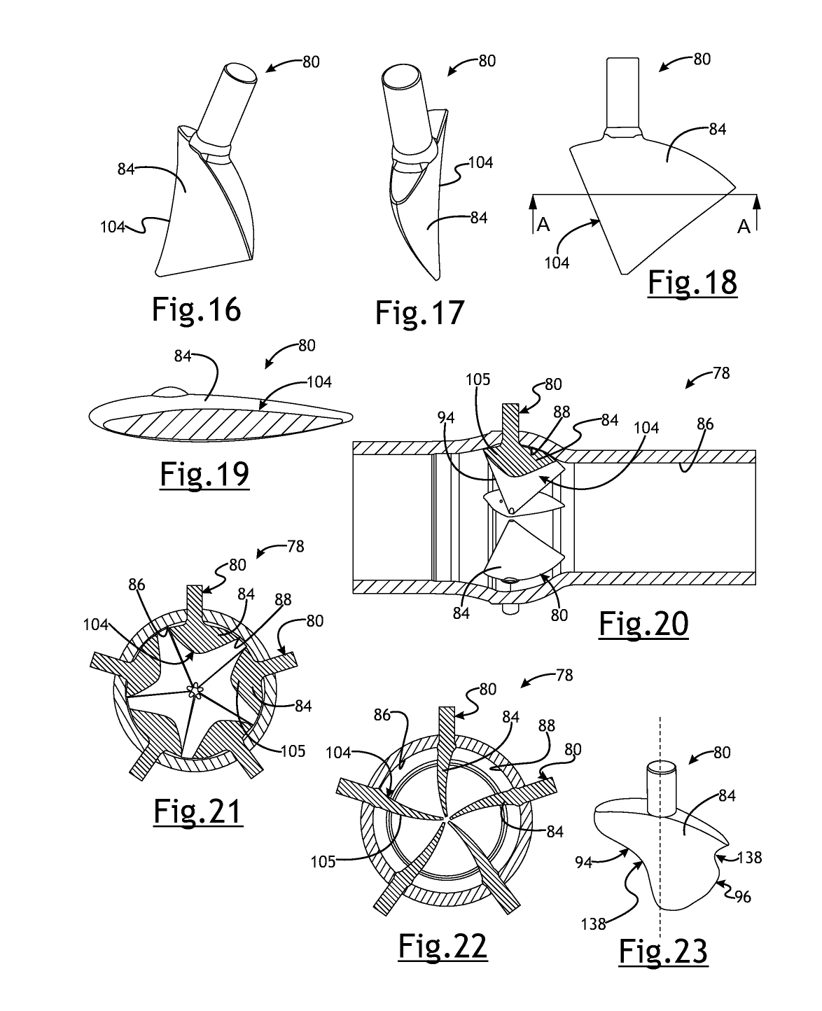

Referring to FIGS. 4-9, in a number of variations, the IGV blade 84 may be twist 100 around the axis of rotation of the IGV 80. In a number of variations, the IGV blade 84 may be twist at an angle between 5 to 30 degrees over the flow channel 86 radius r. Referring to FIGS. 10-15, in a number of variations, the IGV blade 84 may be twist 102 around the leading edge 94 of the IGV blade 84. In a number of variations, the IGV blade 84 may be twist at an angle between 5 to 30 degrees over the flow channel radius r. Referring to FIGS. 16-22, in a number of variations, the IGV blade 84 may include a curved or skewed 104 center line. Referring to FIG. 23, in a number of variations, the IGV blade 84 may be swept 138 on at least one of the leading edge 94 or the trailing edge 96 which may improve acoustics and which may also reduce pressure losses.

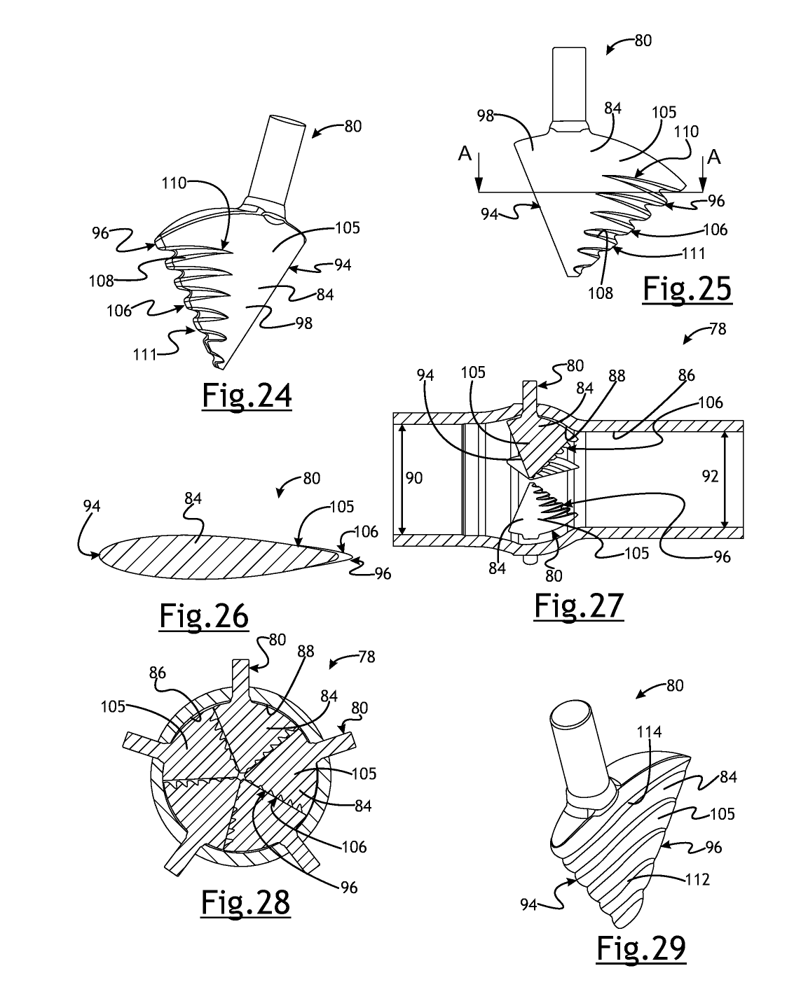

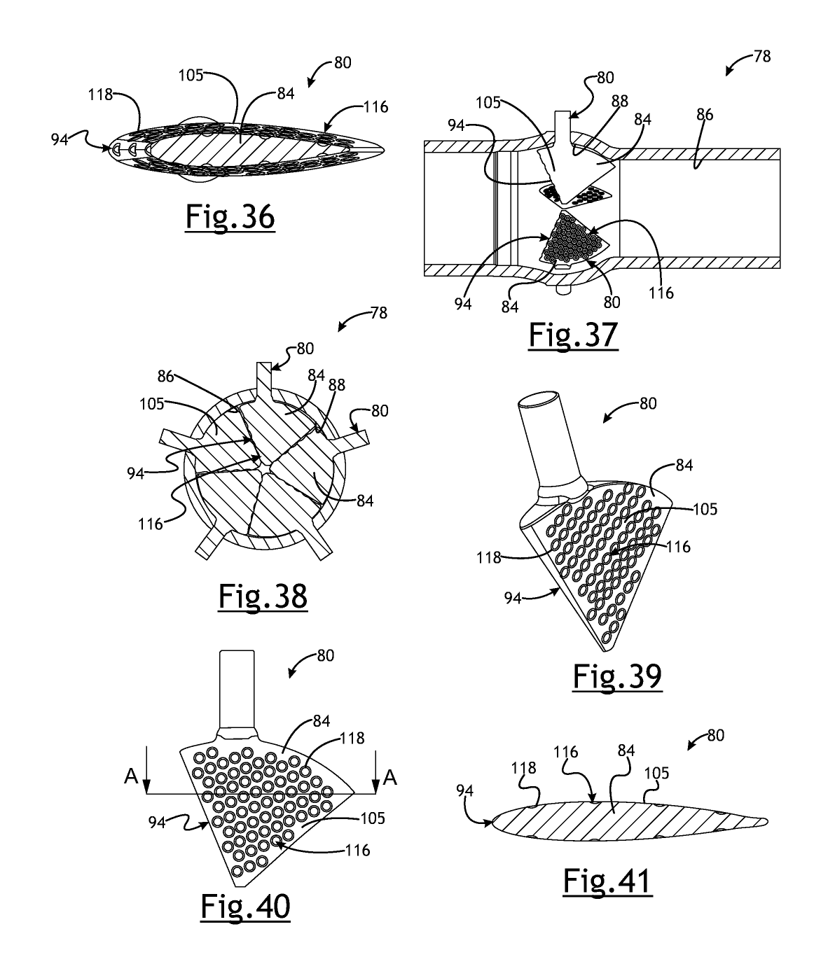

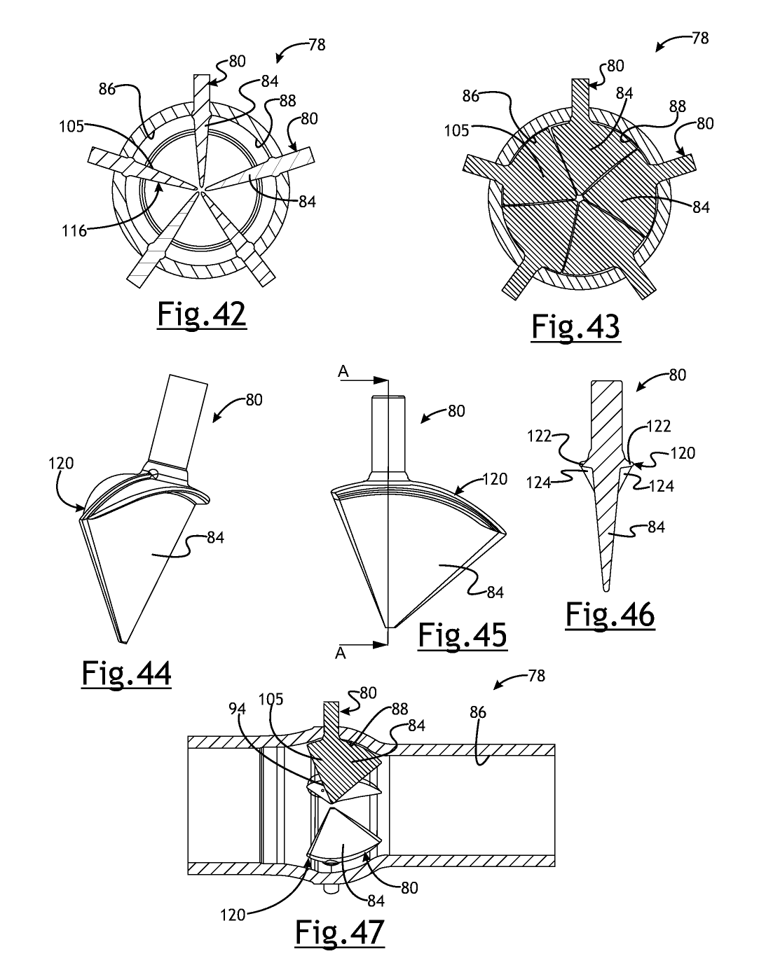

Referring to FIGS. 24-43, in a number of variations, the IGV blades 84 may include surface modifications 106, 112, 116 which may reduce pressure losses. Referring to FIGS. 24-28, in a number of variations, the surface 105 of the IGV blade 84 may include an owl pattern 106 at the trailing edge 96 and/or the leading edge 94 of the IGV blade 84. The owl pattern 106 may include several indentations or cutouts 108 which may extend horizontally across a portion of the IGV blade 84 and which may increase in length as they progress upward toward the top of the IGV blade 84 where the width may be the greatest, a variation of which is illustrated in FIGS. 24-25. Each indentation or cutout 108 may also include a taper 110 as it extends into the body 98 of the IGV blade 84. The indentations or cutouts 108 may also form a serrated surface 111 on the trailing edge 96 and/or the leading edge 94 of the IGV blade 84. This may allow for reduced separation at the trailing edge 96 and/or the leading edge 94 of the IGV blade 84 which may reduce losses of the IGV blade 84 and may improve the inlet profile at the compressor wheel inlet and may also improve acoustics.

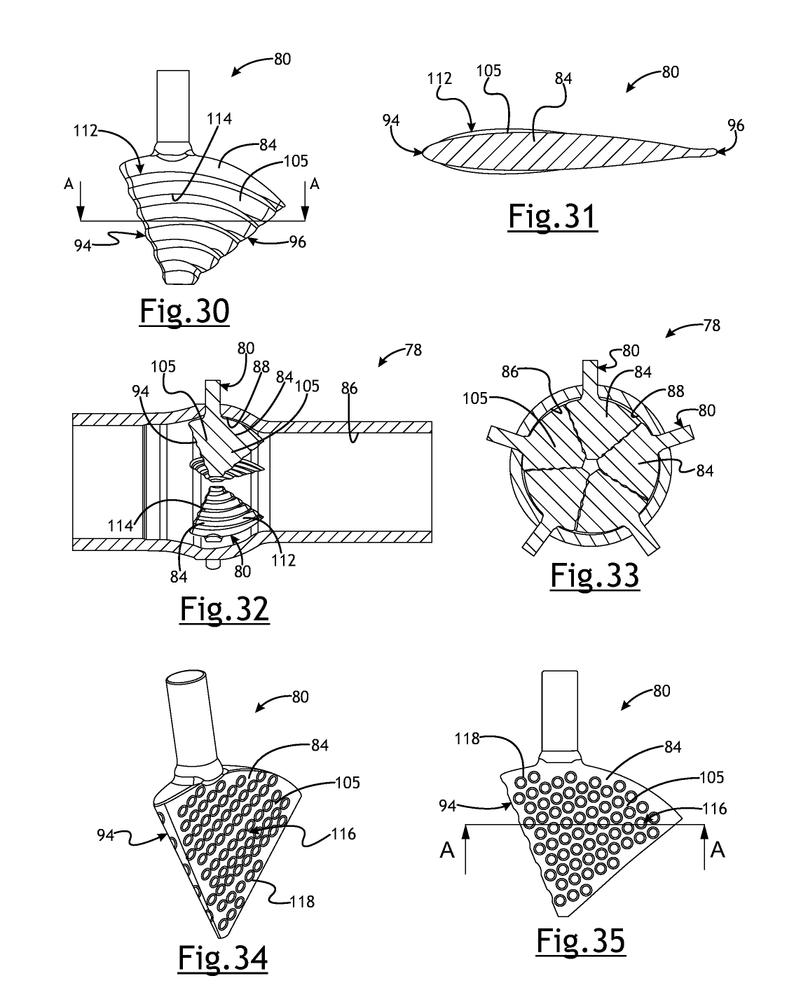

Referring to FIGS. 29-33, in a number of variations, the surface 105 of the IGV blade 84 may include a whale or segmented pattern 112. The whale or segmented pattern 112 may include a plurality of indents or cutouts 114 which may extend horizontally across the length of each side of the IGV blade 84 as well as the leading edge 94 and trailing edge 96, a variation of which is illustrated in FIGS. 29-30. The whale or segmented pattern 112 may improve the flow around the IGV blade 84 and may reduce the losses of the IGV blade 84. The whale or segmented pattern 112 may also improve flow at high angles.

Referring to FIGS. 34-43, in a number of variations, the surface 105 of the IGV blade 84 may include a golf ball pattern 116. In a number of variations, the golf ball pattern 116 may extend across the entire surface 105 of the IGV blade 84 including the leading edge 94, a variation of which is illustrated in FIGS. 34-38. In a number of variations, the golf ball pattern 116 may extend across the front and rear surface 105 of the IGV blade 84 and not the leading edge 94, a variation of which is illustrated in FIGS. 39-43. The golf ball pattern 116 may comprise a plurality of dimples 118, variations of which are illustrated in FIGS. 34-36 and 39-41, or other structured surface. The golf ball pattern 116 may improve the boundary layer around the IGV blades 84 which may reduce pressure losses.

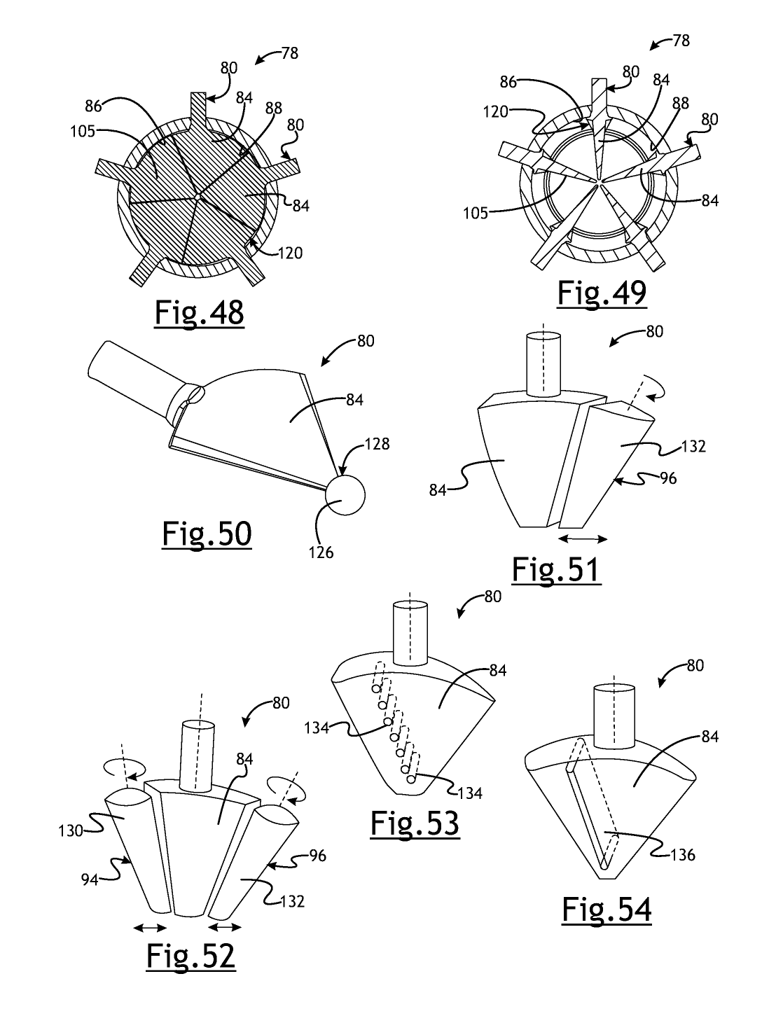

Referring to FIGS. 44-50, in a number of variations, the IGV blades 84 may be modified to reduce secondary flow using a sealing feature 120 and/or a feature reducing the tip 128 leakage 126. Referring to FIGS. 44-49, a winglet 120 may be used to act as a sealing feature to reduce secondary flow. The winglet 120 may include a first and second lip 122 which may extend from each side of the IGV blade 84 and may also include a first and second rib 124 which may extend downward from the first and second lip 122, a variation of which is illustrated in FIG. 46. The first and second ribs 124 may taper as they extend downward, a variation of which is also illustrated in FIG. 46. The winglet 120 may be on the IGV blade 84 pressure side and/or in the gap between the IGV blade 84 and the flow channel 86 which may reduce the flow in the gap. The winglet 120 may act as a labyrinth seal towards the spherical outer chamber 88 of the flow channel 86.

Referring to FIG. 50, in a number of variations, one of the IGV blades 84 may include a sphere 126 at the tip 128 of the IGV blade 84 which may act as a blocking feature by reducing losses created by through-flow of the gas in the middle of the IGV blades 84. The sphere 126 at the tip 128 of the IGV blade 84 may block undesired flow around the IGV blade tips 128.

Referring to FIGS. 51 and 52, in a number of variations, the IGV blade 84 may include an airfoil comprising one or more parts 130, 132 which may increase the angle of attack without flow separations, similar to an aircraft wing during landing. In a number of variations, the airfoil may comprise a flap or slat 132 which may be attached to the IGV blade 84 so that the flap or slat 132 may rotate around a vertical axis of rotation and/or so it may translate outward and inward from the IGV blade 84. In a number of variations, the rotational axis of the flap or slat 132 may be parallel to the IGV vane 84. In a number of variations, the rotational axis of the flap or slat 132 may not be parallel to the IGV vane 84 which may provide additional freedom in adjusting the downstream swirl. The flap or slat 132 may comprise the trailing edge 96 of the IGV blade 84, a variation of which is illustrated in FIG. 51, or the leading edge 94. In a number of variations, the airfoil may comprise a first flap or slat 130 attached to the IGV blade 84 which may comprise the leading edge 94 of the IGV blade 84 and a second flap or slat 132 attached to the IGV blade 84 which may comprise the trailing edge 96 of the IGV blade 84, a variation of which is illustrated in FIG. 52. The flaps or slats 130, 132 may be attached to the IGV blade 84 so that the flaps or slats 130, 132 may rotate around a vertical axis of rotation and/or so they may translate outward and inward from the IGV blade 84. In a number of variations, the rotational axis of the flap or slat 130, 132 may be parallel to the IGV vane 84. In a number of variations, the rotational axis of the flap or slat 130, 132 may not be parallel to the IGV vane 84 which may provide additional freedom in adjusting the downstream swirl. The rotation and/or translation of the flaps or slats 130, 132 above may be achieved through the use of one or more actuators (not illustrated), or the position may be adjusted while adjusting the position of the IGV vanes 84 so that an additional actuator is not required for positioning of the flaps or slats 130, 132. The rotational and/or translational movement of the flaps or slats 130, 132 may allow varying amounts of fluid through the gap (which may be variable) which may stabilize the flow of fluid when necessary. The flaps or slats 130, 132 may be attached to the IGV blade 84 by any number of mechanical mechanisms known to those skilled in the art.

Referring to FIGS. 53 and 54, in a number of variations, the IGV blade 84 may include at least one channel 134, 136 which may direct the flow of fluid from the suction side of the IGV blade 84 through the at least one channel 134, 136 which may stabilize the flow. In a number of variations, the IGV blade 84 may comprise a plurality of channels 134 which may extend through the IGV blade 84, a variation of which is illustrated in FIG. 53. In a number of variations, the plurality of channels 134 may each be cylindrical in shape. In a number of variations, the IGV blade 84 may comprise a single channel 136 which may extend through the IGV blade 84, and may extend more than half the height of the IGV blade 84, a variation of which is illustrated in FIG. 54. In a number of variations, the single channel 136 may be rectangular in shape.

It is noted that any of the IGV blade modifications illustrated above may be combined, particularly those addressing different issues. The use of the modified IGV blades 84 may allow for compressor map extension by shifting both the surge and choke line, may improve exhaust gas recirculation (EGR) mixing, may improve the compressor response (time-to-torque), and/or may eliminate the hot side EGR valve.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a method of optimizing inlet guide vane performance comprising: modifying an inlet guide vane to include at least one of a twist, a curve, a surface texture, a sealing feature, a tip leakage reduction feature, an airfoil having at least one component, or at least one channel.

Variation 2 may include a method as set forth in Variation 1 wherein the twist or the curve of the inlet guide vane tailors a pre-swirl level over a flow channel radius.

Variation 3 may include a method as set forth in any of Variations 1-2 wherein the surface texture of the inlet guide vane reduces pressure losses.

Variation 4 may include a method as set forth in any of Variations 1-3 wherein the sealing feature or the blocking feature on the inlet guide vane reduces secondary flow.

Variation 5 may include a method as set forth in any of Variations 1-4 wherein the airfoil or the at least one channel improves flow through a flow channel.

Variation 6 may include a product comprising: an inlet guide vane having at least one of a twisted blade, a curved blade, a surface texture, a sealing feature, a blocking feature, an airfoil having at least one component, or at least one channel.

Variation 7 may include a product as set forth in Variation 6 wherein the twisted blade is twisted around at least one of an axis of rotation of the inlet guide vane or the leading edge of the inlet guide vane.

Variation 8 may include a product as set forth in any of Variations 6-7 wherein the curved blade is at least one of curved around a center line of the inlet guide vane or skewed around at least one of a leading edge or a trailing edge of the inlet guide vane.

Variation 9 may include a product as set forth in any of Variations 6-8 wherein the surface texture comprises an owl construction including a plurality of indentations which extend horizontally along a portion of a first and a second side of the blade from at least one of a trailing edge or a leading edge of the blade and increases in length as the blade width increases and wherein the plurality of indentations each taper.

Variation 10 may include a product as set forth in any of Variations 6-9 wherein the surface texture comprises a whale construction, wherein a first and a second side of the blade include a plurality of grooves which extend across the width of the blade.

Variation 11 may include a product as set forth in any of Variations 6-10 wherein the surface texture includes a golf ball pattern along at least one of a front surface, a rear surface, or a leading edge of the blade.

Variation 12 may include a product as set forth in any of Variations 6-11 wherein the seal feature comprises a winglet which includes a first and a second lip which extend from a top portion of the inlet guide vane and a first rib and a second rib which taper downward from the first and the second lip.

Variation 13 may include a product as set forth in any of Variations 6-12 wherein the tip leakage reduction feature comprises a spherical ball at a tip of the blade.

Variation 14 may include a product as set forth in any of Variations 6-13 wherein the airfoil comprises at least one flap mechanically attached to the inlet guide vane at an edge of the inlet guide vane, and wherein the at least one flap is constructed and arranged for at least one of rotational or translational movement.

Variation 15 may include a product as set forth in any of Variations 6-14 wherein the at least one channel comprises a plurality of channels which extend through the inlet guide vane.

Variation 16 may include a product as set forth in Variation 15 wherein the plurality of channels are each cylindrical.

Variation 17 may include a product as set forth in any of Variations 6-14 wherein the at least one channel comprises a single channel which extends through the inlet guide vane.

Variation 18 may include a product as set forth in Variation 17 wherein the single channel is rectangular.

Variation 19 may include a product as set forth in any of Variations 6-18 further comprising an inlet swirl device having an inlet port, a flow channel, and an outlet port, and wherein a plurality of inlet guide vanes are operatively attached to the flow channel.

Variation 20 may include a product as set forth in Variation 19 wherein a rotational axis of each inlet guide vane is placed at a quarter profile length from a leading edge of the inlet guide vane.

The above description of select variations within the scope of the invention is merely illustrative in nature and, thus, variations or variants thereof are not to be regarded as a departure from the spirit and scope of the invention.

What is claimed is:

1. A method of optimizing inlet guide vane performance comprising: modifying an inlet guide vane to include at least one of a twist, a curve, a surface texture, a sealing feature, a tip leakage reduction feature, an airfoil having at least one component, or at least one channel.

2. The method of claim 1 wherein the twist or the curve of the inlet guide vane tailors a pre-swirl level over a flow channel radius.

3. The method of claim 1 wherein the surface texture of the inlet guide vane reduces pressure losses.

4. The method of claim 1 wherein the sealing feature or the blocking feature on the inlet guide vane reduces secondary flow.

5. The method of claim 1 wherein the airfoil or the at least one channel improves flow through a flow channel.

6. A product comprising: an inlet guide vane having at least one of a twisted blade, a curved blade, a surface texture, a sealing feature, a blocking feature, an airfoil having at least one component, or at least one channel.

7. The product of claim 6 wherein the twisted blade is twisted around at least one of an axis of rotation of the inlet guide vane or the leading edge of the inlet guide vane.

8. The product of claim 6 wherein the curved blade is at least one of curved around a center line of the inlet guide vane or skewed around at least one of a leading edge or a trailing edge of the inlet guide vane.

9. The product of claim 6 wherein the surface texture comprises an owl construction including a plurality of indentations which extend horizontally along a portion of a first and a second side of the blade from at least one of a trailing edge or a leading edge of the blade and increases in length as the blade width increases and wherein the plurality of indentations each taper.

10. The product of claim 6 wherein the surface texture comprises a whale construction, wherein a first and a second side of the blade include a plurality of grooves which extend across the width of the blade.

11. The product of claim 6 wherein the surface texture includes a golf ball pattern along at least one of a front surface, a rear surface, or a leading edge of the blade.

12. The product of claim 6 wherein the seal feature comprises a winglet which includes a first and a second lip which extend from a top portion of the inlet guide vane and a first rib and a second rib which taper downward from the first and the second lip.

13. The product of claim 6 wherein the tip leakage reduction feature comprises a spherical ball at a tip of the blade.

14. The product of claim 6 wherein the airfoil comprises at least one flap mechanically attached to the inlet guide vane at an edge of the inlet guide vane, and wherein the at least one flap is constructed and arranged for at least one of rotational or translational movement.

15. The product of claim 6 wherein the at least one channel comprises a plurality of channels which extend through the inlet guide vane.

16. The product of claim 15 wherein the plurality of channels are each cylindrical.

17. The product of claim 6 wherein the at least one channel comprises a single channel which extends through the inlet guide vane.

18. The product of claim 17 wherein the single channel is rectangular.

19. The product of claim 6 further comprising an inlet swirl device having an inlet port, a flow channel, and an outlet port, and wherein a plurality of inlet guide vanes are operatively attached to the flow channel.

20. The product of claim 19 wherein a rotational axis of each inlet guide vane is placed at a quarter profile length from a leading edge of the inlet guide vane.
